(19) United States
(12) Patent Application Publication
(10) Pub. No.: US 2009/0250535 A1
(43) Pub. Date: Oct. 8, 2009

(54) Waste treatment vessel with two doors and environmental separation between doors

(75) Inventor: Jan K. Michalek, Pataskala, OH (US)

Correspondence Address: ROGER A. GILCREST, 250 WEST STREET, COLUMBUS, OH, 43216-7513, US

(73) Assignee: Estech, LLC, Canal Winchester, OH (US)

(21) Appl. No.: 12/384,579

(22) Filed: Apr. 7, 2009

Related U.S. Application Data
(60) Provisional application No. 61/123,351, filed on Apr. 7, 2008.

(51) Int. Cl. B02C 17/18

(52) U.S. Cl. 241/23; 241/65

(57) ABSTRACT

The present invention includes an apparatus for processing solid waste products, the apparatus comprising: (a) a rotatably mounted cylindrical vessel having a first end and a second end, a hatch at both the first end and the second end that may be opened to allow access to the interior of the vessel to a respective first and second environmental space outside the interior of the vessel, and sealably closed to allow pressurization of the vessel; (b) a steam inlet for injecting steam into at least one of the ends; and (c) an environmental barrier for at least partially separating the environments of the first and second environmental space.

### RELATED APPLICATION DATA

This application claims the priority benefit of U.S. Provisional Application No. 61/123,351, filed Apr. 7, 2008, which is hereby incorporated in its entirety herein by reference.

### TECHNICAL FIELD

The present invention relates to the treatment of municipal solid waste and the like.

### BACKGROUND OF THE INVENTION

The present invention relates to systems and methods for treating process material and, more particularly, to systems and methods for treating municipal solid waste material, medical waste material, reclaimed paper and the like.

As a result of increasing scarcity of landfills and more stringent environmental regulations, efforts have been made to reduce the volume of process material, such as municipal solid waste (“MSW”) and paper material, such as newsprint and other reclaimed and recycled paper products as a step in the process of disposing of the material, either by depositing it in landfills, incinerating it or recycling it.

Systems and methods have been developed to break down such material for disposal, or in the case of paper products, use as insulation.

An example of such a process and device is U.S. Pat. No. 5,190,226, which discloses an apparatus and method for separation, recovery and recycling of MSW. The apparatus includes a rotating drum which is fed at an upstream end by a reciprocating ram, a steam source which is connected to introduce high temperature steam into the drum, and a spiral rib or flight mounted within the drum to transport material deposited in an upstream end of the drum along the length of the drum.

Another example is described in U.S. Pat. No. 5,119,994 that describes a steam treatment vessel held stationary, preferably at an angle to the horizontal.

One method of attempting to achieve more efficient treatment is described in U.S. Pat. No. 6,397,492 and involves the continual supply of steam during loading, while simultaneously rotating the vessel, so as to break down the waste during loading to a material of roughly uniform density, so that the same mass of waste is processed in each batch. However, this process requires a separate steam treatment during loading which results in greater overall time requirements for each waste batch.

One of the disadvantages of the arrangements of the prior art is that the environments surrounding the vessel may be harmful to those loading, operating or discharging the vessel.

Accordingly, it is also advantageous to be able to provide safe and functional working environments around vessels of this type, for persons involved in loading, operating or discharging the vessel or otherwise.

In this same regard, the environment surrounding the vessel upon loading differs from that surrounding the vessel upon discharge. As these environments differ, it is also desirable to be able to provide a waste treatment vessel that may be loaded, operated or discharged while maintaining some degree of separation or isolation of the loading environment from the discharge environment.

The present invention accordingly represents an improvement over prior art apparatus and methods, such as those described in U.S. Pat. Nos. 5,540,391; 5,116,363; 5,253,764; 5,190,226; 5,361,994; 5,427,650; 5,407,809; and 6,397,492, all of which are hereby incorporated herein by reference. PCT application PCT/US06/16773 and co-pending patent application Ser. No. 11/716,101 are also incorporated herein by reference. PCT Published application WO2006056768 A9 is also hereby incorporated herein by reference.

### SUMMARY OF THE INVENTION

The present invention includes an apparatus for processing solid waste products, the apparatus comprising: a rotatably mounted cylindrical vessel having a first end and a second end, a hatch at both the first end and the second end that may be opened to allow access to the interior of the vessel to a respective first and second environmental space outside the interior of the vessel, and sealably closed to allow pressurization of the vessel; a steam inlet for injecting steam into at least one of the ends; and means for at least partially separating the environments of the first and second environmental space.

The present invention may be adapted to be used in accordance with prior vessel systems such as those described in the incorporated references.

Examples of means for at least partially separating the first and second environments include a wall through which the vessel extends, an air curtain through which the vessel extends, a material curtain through which the vessel extends and a trough adapted to accept liquids from at least one of the environmental spaces.

### Apparatus With Environmental Barrier

The present invention includes an apparatus for processing solid waste products, the apparatus comprising: (a) a rotatably mounted cylindrical vessel having a first end and a second end, a hatch at both the first end and the second end that may be opened to allow access to the interior of the vessel to a respective first and second environmental space outside the interior of the vessel, and sealably closed to allow pressurization of the vessel; (b) a steam inlet for injecting steam into at least one of the ends; and (c) an environmental barrier for at least partially separating the environments of the first and second environmental space.

It is preferred that the environmental barrier for at least partially separating the environments of the first and second environmental space includes a wall through which the vessel extends. This may take the form of air curtain through which the vessel extends and/or a trough adapted to accept liquids from at least one of the environmental spaces. It may also include a curtain or a wall through which the vessel extends. Another preferred embodiment includes the use of bearings between the barrier material and a flexible material, such as a rubber gasket, and between the flexible material and the vessel so as to permit rotation and/or translocation of the vessel while maintaining the seal. As an alternative, the flexible material may be fixed to the barrier material and be made simply to bear against the vessel with enough force so as to permit rotation and/or translocation of the vessel while maintaining the seal.

It is also preferred that a pressure gradient is maintained between the environments of the first and second environmental space, such as by having the first environmental space (i.e., the upstream, waste input side of the vessel) be defined by a chamber and wherein the chamber is maintained under a positive air pressure.

### Apparatus With Chambers Enclosing Separate Ends

In another preferred embodiment, the apparatus for processing solid waste products includes: (a) a rotatably mounted cylindrical vessel having a first end and a second end, a hatch at both the first end and the second end that may be opened to allow access to the interior of the vessel to a respective first and second environmental space outside the interior of the vessel, and sealably closed to allow pressurization of the vessel; (b) a steam inlet for injecting steam into at least one of the ends; and (c) an environmental barrier for at least partially separating the environments of the first and second environmental space; (d) an environmental chamber enclosing the first environmental space; and (e) an environmental chamber enclosing the second environmental space.

In a preferred embodiment, the environmental barrier for at least partially separating the environments of the first and second environmental space includes a wall through which the vessel extends and, optionally a device to maintain an air pressure differential between the first and second environmental spaces, such that air flow is urged from the first environmental space toward the second environmental space. Preferably, the first environmental space (i.e., the upstream, waste input side of the vessel) is defined by a chamber and wherein the chamber is maintained under a positive air pressure.

The environmental barrier may optionally include an air curtain provided to create a flow of air between the first and second environments.

It is preferred that the first and second environments be substantially completely isolated from the cross-flow of gases, liquids or other materials, such as particulates. In appropriate cases, an optional trough and/or half wall may be used to at least partially isolate the first and second environments from one another.

In a further preferred embodiment, the system includes a combustion chamber for combusting processed solid waste products from the vessel, and additionally comprising an air conduit adapted to conduct air from the first environmental space to the combustion chamber.

The vessel further includes at least one door or hatch, or similar means to access the interior of the vessel for loading and unloading the waste charge, which may be transported to the vessel by a conveyor or other traditional means.

The apparatus typically includes a means for rotating the vessel, such as those known and used in the art, such as trunnion rings and rollers, or chain-driven gear and sprocket systems or a “spud” ring. Any stable method of rotating the vessel at a controlled speed would be suitable. The rotation of the vessel however must also be able to accommodate its movement by the actuator(s) as described herein.

The vessel system may have many of the same characteristics of those known and used in the art, in terms of being designed to contain large quantities of matter (i.e., several tons) and to hold those contents under pressure. Examples are described in the incorporated references, and are known in the art.

The vessel may be supported in any fashion that allows movement while rotating, or it may be rotated while stationary. It is preferred that the vessel be supported by a hinged fulcrum point about which it may be moved.

In case where the vessel allows vertical and/or horizontal movement while rotating, the environmental barrier may be provided with structure, such as a flexible, heat resistant material to allow for the movement(s) of the vessel while it extends through the environmental barrier. Such materials may include a curtain of a heat resistant material, such as fiberglass, or a flexible collar about the vessel of a heat resistant material.

### Method of Processing While Maintaining Separate Environments

The present invention also generally includes a method for processing solid waste products, the apparatus comprising: (a) placing solid waste in a rotatably mounted cylindrical vessel having a first end and a second end, a hatch at both the first end and the second end that may be opened to allow access to the interior of the vessel to a respective first and second environmental space outside the interior of the vessel, and sealably closed to allow pressurization of the vessel; (b) placing a steam inlet for injecting steam into at least one of the ends while (c) maintaining an environmental barrier for at least partially separating the environments of the first and second environmental space.

It is preferred that a pressure gradient is maintained between the environments of the first and second environmental space. It is also preferred that the second environmental space is defined by a chamber and wherein the chamber is maintained under a positive air pressure with respect to the first environmental space.

### BRIEF DESCRIPTION OF THE DRAWINGS

FIG. 1 is a perspective and partially sectioned view of an apparatus for processing solid waste products disposed in a chamber system in accordance with one embodiment of the present invention.

FIG. 2 is a plan and partially sectioned view of an apparatus for processing solid waste products disposed in a chamber system in accordance with one embodiment of the present invention.

FIG. 3 is an elevation view taken along line 3-3 of FIG. 2 of an apparatus for processing solid waste products disposed in a chamber system in accordance with one embodiment of the present invention.

FIG. 4 is cross-section view of a gasket-bearing barrier portion in a chamber system in accordance with one embodiment of the present invention.

FIG. 5 is cross-section view of a gasket-bearing barrier portion in a chamber system in accordance with an alternative embodiment of the present invention.

### DETAILED DESCRIPTION OF THE PREFERRED EMBODIMENT

In accordance with the foregoing summary, the following provides a detailed description of the preferred embodiment, which is presently considered to be the best mode thereof.

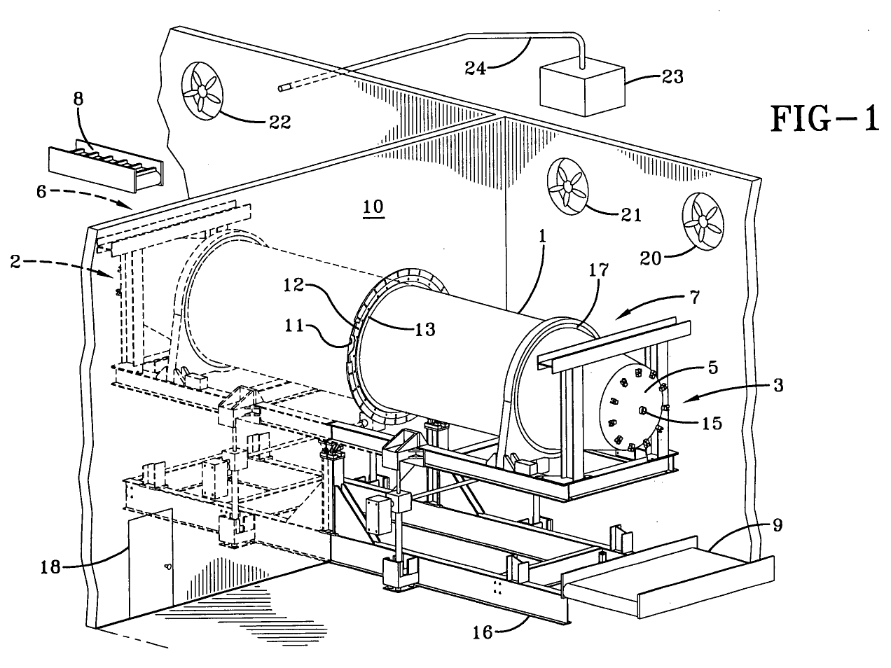

FIG. 1 is a perspective and partially sectioned view of an apparatus for processing solid waste products disposed in a chamber system in accordance with one embodiment of the present invention.

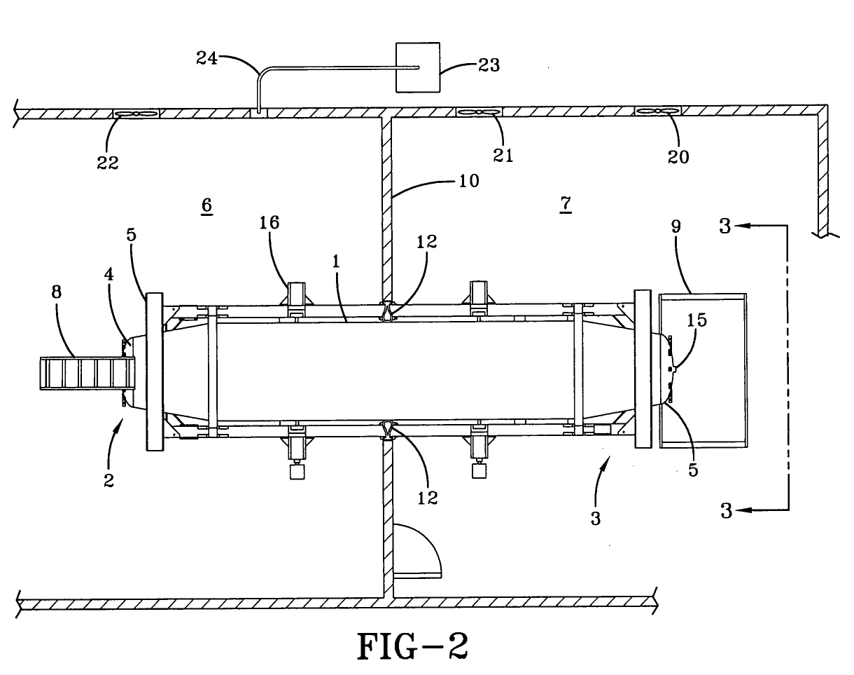

FIG. 1 shows a rotatably mounted cylindrical vessel 1 having a first end 2, a second end 3, with the first end 2 having a hatch 4 (see FIG. 2) and the second end 3 having a hatch 5, that may be opened to allow access to the interior of the vessel and sealably closed to allow pressurization of the vessel. The first end 2 of vessel 1 extends into chamber 6 such that hatch 4 allows the first end 2 of the vessel 1 to be opened to allow access to the interior of the vessel so that it may be loaded at the first end 2 from chamber 6 such as by action of conveyor 8.

Conversely, the second end 3 of vessel 1 extends into chamber 7 such that hatch 5 allows the second end 3 of the vessel 1 to be opened to allow access to the interior of the vessel so that the processed waste may be removed from the second end 3 into chamber 7 such as by action of conveyor 9. This also may be done by using a ram that may push the treated charge from the vessel by extending through the vessel 1.

FIG. 1 shows one of the several examples of environmental barriers of the type that may be used in accordance with the present invention to separate the environment around the first end 2 from the environment around second end 3. FIG. 1 shows wall 10 that optionally may be disposed between the first end and second end environments. The wall may be made of any appropriate material, such as mason, wood, etc., and may also be in the form of a curtain-like material, such as canvas or plastic. Wall 10 may have a closeable opening, such as Door 18 for access between the two environments. In a preferred embodiment, the environmental barrier may take the form of a wall 10 with an aperture 11 allowing the vessel 1 to extend therethrough, and preferably having a sealing material 12 such as a canvas, rubber or fiberglass material that optionally may be attached to the wall 10 and the vessel 1 in such a way as to allow the vessel to rotate and/or move. This may be done using a bearing ring 13 attached to the vessel 1 body that allows the vessel to move while attached to the sealing material 12 which in turn is attached to the wall 10, or vice versa.

Also shown in FIG. 1 is a steam inlet 15 for injecting steam at one or both of the ends, and preferably at both ends. Steam inlet 15 may be connected to steam conduits (not shown) so as to introduce and maintain steam pressure into the vessel.

The vessel 1 may be rotated with respect to upper frame portion 16, such as by virtue of mechanical sleeve drives 17. The apparatus also includes at least one motor or other means for rotating the vessel.

The preferred vessel system is that described in co-pending patent application Ser. No. 11/716,101 and PCT Published application WO2006056768 A9 which describes a moveable vessel. The environmental barrier system may be adapted to permit rotational and vertical movement of the vessel, such as through the provision of an appropriately sized and dimensioned aperture 11 that allows the vessel 1 to move with respect to the balance of the wall 10 as it extends therethrough, and by preferably having a sealing material 12 of sufficient size and flexibility to accommodate that range of movement.

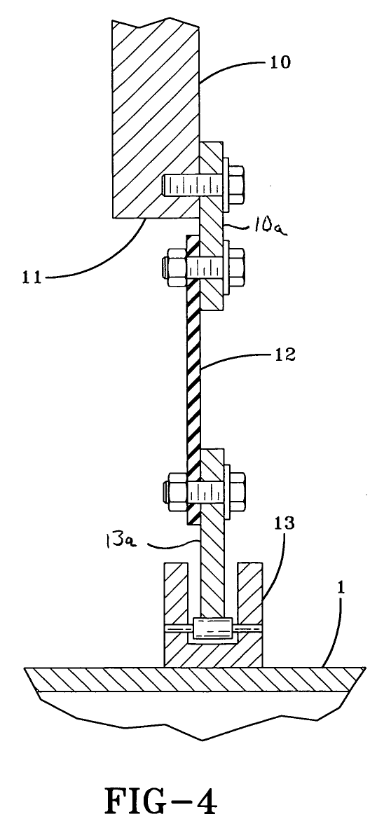

FIG. 4 is cross-section view of a gasket-bearing barrier portion in a chamber system in accordance with one embodiment of the present invention. FIG. 4 shows wall 10 attached to circular attachment flange 10a which in turn is attached to sealing material 12. Sealing material 12 is in turn connected to circular attachment flange 13a that engages the vessel 1 through a bearing ring 13 so as to allow for the rotation of the vessel 1 during processing.

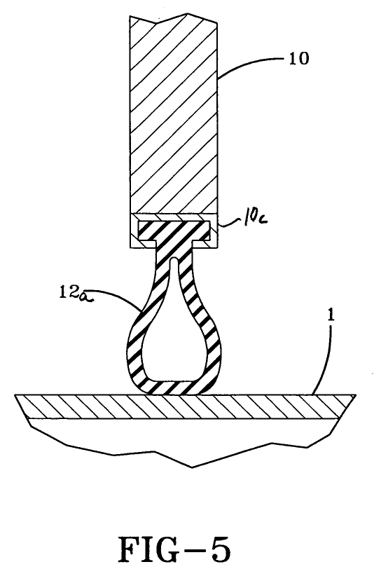

FIG. 5 is cross-section view of a gasket-bearing barrier portion in a chamber system in accordance with an alternative embodiment of the present invention. FIG. 5 shows wall 10 attached to circular attachment flange 10c which in turn is attached to sealing material 12a. Sealing material 12a in turn engages the vessel 1 through a resilient bearing action against vessel 1 so as to allow for the rotation of the vessel 1 during processing.

FIG. 2 is a plan view of an apparatus for processing solid waste products disposed in a chamber system in accordance with one embodiment of the present invention, using the same reference numerals for portions already discussed. This view also shows access doors 4 and 5.

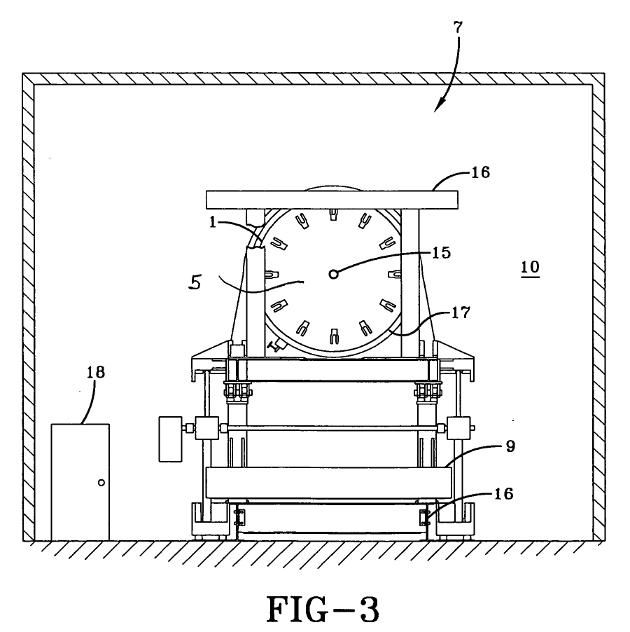

FIG. 3 is an elevation view taken along line 3-3 of FIG. 2 of an apparatus for processing solid waste products disposed in a chamber system in accordance with one embodiment of the present invention, and uses the same reference numerals as FIG. 1 and 2.

FIG. 3 shows, using the same reference numbers shown in FIG. 1, a rotatably mounted cylindrical vessel 1 as depicted in FIG. 1 with the first end and the second end at about the same height such that the vessel is horizontal. This position is typical of those at which the vessel would be maintained during operation, with relatively small adjustments being made to urge the charge of waste products toward either end in order to level the load of waste products. This view also shows the second hatch 5 (having steam inlet 15) which is used as an exit hatch for the treated waste product charge.

The invention relates to a process for recycling waste. This process is sterilizing high density materials such as glass, plastics, metals and recovering others from municipal solid waste (MSW) and converting paper, cardboard, food waste, etc. to a usable fiber and separating it from other recyclable materials.

The views of FIGS. 3 and 4 are used for illustrative purposes only, and it will be understood that the vessel may be tilted to lesser degrees during processing in order to make lesser adjustments in the load distribution through leveling, and that such movement may be relatively rapid or slower and/or repetitive, depending upon the load situation presented.

After the vessel is loaded with the charge of waste products, the door through which the charge was loaded is shut, steam is introduced continually into the vessel, and the vessel becomes pressurized. Fresh steam may be continuously fed into the vessel from the loading end, and after a predetermined processing pressure is reached, steam may be allowed to escape the vessel into the discharge steam line.

In the preferred embodiment, a positive airflow is maintained between the first chamber 6 and the second chamber 7. This may be done by action of air movement devices such as fans 20 and 21 which force air into chamber 7 while fan 22 draws air out of chamber 6.

In a further preferred embodiment, the system includes a combustion chamber 23 for combusting processed solid waste products from the vessel, and additionally comprising an air conduit 24 adapted to conduct air from the first environmental space of first chamber 6 to the combustion chamber 23. The combustion chamber may be any chamber where combustion may occur and may include portions of systems designed to combust materials processed by the vessel 1. This assists in keeping the environment in chamber 7 relatively cleaner and free of odors.

The air removed from the first chamber 6 therefore is treated so as to remove odoriferous substances therefrom.

The chambers 6 and 7 typically will be closed from the outside environment to allow pressurization, although it will be understood that the present invention may still operate in instances where the separated environments may be opened temporarily to allow loading and unloading of the waste material from the vessel. Typically however, the downstream chamber will remain closed to allow its pressurization relative to the first chamber and the ambient atmosphere. This maintains the respective environments in a state where transmission of gases and the like from the upstream environment to the downstream environment are resisted. This helps maintain the cleanliness of the downstream environment to prevent contamination of the processed material and to make the working environment more suitable and pleasant for those working in the downstream environment. The preferred embodiment of the present invention also is capable of remediating odors to prevent the release to the environment in general.

It is apparent that while specific embodiments of the invention is disclosed, various modifications of the apparatus or parameters of the process may be made which will be within the spirit and scope of the invention. Therefore the spirit and scope of the present invention should be determined by reference to the claims below.

What is claimed is: Apparatus With Environmental Barrier

1. An apparatus for processing solid waste products, said apparatus comprising:
a rotatably mounted cylindrical vessel having a first end and a second end, at least one a hatch at both the first end and the second end that may be opened to allow access to the interior of said vessel to a respective first and second environmental space outside said interior of said vessel, and sealably closed to allow pressurization of said vessel;
a steam inlet for injecting steam into at least one of said ends; and
an environmental barrier for at least partially separating the environments of said first and second environmental space.

2. An apparatus according to claim 1, wherein said environmental barrier for at least partially separating the environments of said first and second environmental space includes a wall through which said vessel extends.

3. An apparatus according to claim 1, wherein said environmental barrier for at least partially separating the environments of said first and second environmental space includes an air curtain through which said vessel extends.

4. An apparatus according to claim 1, wherein said environmental barrier for at least partially separating the environments of said first and second environmental space includes a trough adapted to accept liquids from at least one of said environmental spaces.

5. An apparatus according to claim 1, wherein said environmental barrier for at least partially separating the environments of said first and second environmental space includes a curtain through which said vessel extends.

6. An apparatus according to claim 1, wherein a pressure gradient is maintained between the environments of said first and second environmental space.

7. An apparatus according to claim 1, wherein said second environmental space is defined by a chamber and wherein said chamber is maintained under a positive air pressure with respect to said first environmental space.

8. An apparatus according to claim 1, wherein said rotatably mounted cylindrical vessel is adapted to be tilted with respect to the horizontal.
Apparatus With Chambers Enclosing Separate Ends

9. An apparatus for processing solid waste products, said apparatus comprising:
a rotatably mounted cylindrical vessel having a first end and a second end, at least one a hatch at both the first end and the second end that may be opened to allow access to the interior of said vessel to a respective first and second environmental space outside said interior of said vessel, and sealably closed to allow pressurization of said vessel;
a steam inlet for injecting steam into at least one of said ends; and
an environmental barrier for at least partially separating the environments of said first and second environmental space; and
an environmental chamber enclosing said first environmental space;
an environmental chamber enclosing said second environmental space.

10. An apparatus according to claim 9, wherein said environmental barrier for at least partially separating the environments of said first and second environmental space includes a wall through which said vessel extends.

11. An apparatus according to claim 9, additionally comprising a device to maintain an air pressure differential between said first and second environmental spaces, such that air flow is urged from said second environmental space toward said first environmental space.

12. An apparatus according to claim 9, wherein said second environmental space is defined by a chamber and wherein said chamber is maintained under a positive air pressure with respect to said first environmental space.

13. An apparatus according to claim 9, additionally comprising a combustion chamber for combusting processed solid waste products from said vessel, and additionally comprising an air conduit adapted to conduct air from said first environmental space to said combustion chamber.
Method of Processing While Maintaining Separate Environments

14. A method for processing solid waste products, said apparatus comprising:
(a) placing solid waste in a rotatably mounted cylindrical vessel having a first end and a second end, at least one a hatch at both the first end and the second end that may be opened to allow access to the interior of said vessel to a respective first and second environmental space outside said interior of said vessel, and sealably closed to allow pressurization of said vessel;
(b) placing a steam inlet for injecting steam into at least one of said ends while
(c) maintaining an environmental barrier for at least partially separating the environments of said first and second environmental space.

15. A method according to claim 14, wherein a pressure gradient is maintained between the environments of said first and second environmental space.

16. A method according to claim 14, wherein said second environmental space is defined by a chamber and wherein said chamber is maintained under a positive air pressure with respect to said first environmental space.

17. A method according to claim 14, wherein said rotatably mounted cylindrical vessel is adapted to be tilted with respect to the horizontal while maintaining an environmental barrier for at least partially separating the environments of said first and second environmental space.
